(19) United States
(12) Patent Application Publication
(10) Pub. No.: US 2014/0192544 A1
(43) Pub. Date: Jul. 10, 2014

(54) READING LIGHT

(71) Applicant: C&D Zodiac, Inc., Huntington Beach, CA (US)

(72) Inventors: Ben Orson, Shell Beach, CA (US); Zhao Jin, Everett, WA (US); Christian Mecke, Hamburg (DE)

(73) Assignee: C&D Zodiac, Inc., Huntington Beach, CA (US)

(21) Appl. No.: 14/150,603

(22) Filed: Jan. 8, 2014

Related U.S. Application Data
(60) Provisional application No. 61/750,950, filed on Jan. 10, 2013.

(51) Int. Cl. F21V 15/01; B64D 47/02

(52) U.S. Cl. CPC F21V 15/012; B64D 47/02
USPC 362/470; 362/269; 362/372

(57) ABSTRACT

A lighting assembly that includes an outer housing defining an outer housing axis, an inner housing defining an inner housing axis and a light member positioned in the inner housing. The outer housing includes a front surface having a front opening and an inner surface that defines an adjustment cavity having a truncated spherical shape. The inner housing has a truncated spherical shape and is at least partially received within the adjustment cavity. The inner housing defines a light recess therein and includes a front cover having an aperture defined therein. The front cover at least partially defines the light recess. The light member defines a light axis. The light axis and the inner housing axis are not co-axial and not parallel and form an angle therebetween. The inner housing is adjustable between a home position and a plurality of adjustment positions.

### CROSS REFERENCE TO RELATED APPLICATIONS

This application claims the benefit of U.S. Provisional Application No. 61/750,950, filed Jan. 10, 2013, which is herein incorporated by reference in its entirety.

### FIELD OF THE INVENTION

The present invention relates generally to a reading light, and more particularly to a reading light for use in an aircraft.

### BACKGROUND OF THE INVENTION

Reading lights are commonly used in commercial aircraft. In many prior art ball-and-socket adjustable reading light the axis of the projected light passes through the center of the ball that is mounted on an angled panel or sub assembly. As a result, a large amount of space is required for installing the light.

### SUMMARY OF THE PREFERRED EMBODIMENTS

In accordance with a first aspect of the present invention there is provided a lighting assembly that includes an outer housing defining an outer housing axis, an inner housing defining an inner housing axis and a light member positioned in the inner housing. The outer housing includes a front surface having a front opening and an inner surface that defines an adjustment cavity having a truncated spherical shape. The inner housing has a truncated spherical shape and is at least partially received within the adjustment cavity. The inner housing defines a light recess therein and includes a front cover having an aperture defined therein. The front cover at least partially defines the light recess. The light member defines a light axis. The light axis and the inner housing axis are not co-axial and not parallel and form an angle therebetween. The inner housing is adjustable between a home position and a plurality of adjustment positions. In a preferred embodiment, in the home position, the inner housing axis and outer housing axis are co-axial, and the inner housing axis and outer housing axis are not co-axial in any of the adjustment positions. Preferably, the light member includes a front lens member having a front surface that defines a center point, and, in the home position, the outer housing axis passes through the center point. In any of the adjustment positions, the outer housing axis does not pass through the center point.

In a preferred embodiment, the front cover has a front surface that slopes inwardly toward the aperture. Preferably, the front cover includes adjustment protrusions and/or adjustment indentations thereon. The front surface of the outer housing preferably includes a switch thereon. In a preferred embodiment, the light member is spaced from the front cover and the aperture.

In accordance with another aspect of the present invention there is provided an aircraft that includes a non-horizontal wall having an opening defined therein, and a lighting assembly positioned in the opening. The light assembly includes an outer housing defining an outer housing axis, an inner housing defining an inner housing axis and a light member positioned in the inner housing. The outer housing includes a front surface having a front opening and an inner surface that defines an adjustment cavity having a truncated spherical shape. The inner housing has a truncated spherical shape and is at least partially received within the adjustment cavity. The inner housing defines a light recess therein and includes a front cover having an aperture defined therein. The front cover at least partially defines the light recess. The light member defines a light axis. The light axis and the inner housing axis are not co-axial and not parallel and form an angle therebetween. The inner housing is adjustable between a home position and a plurality of adjustment positions. In a preferred embodiment, the non-horizontal wall is a portion of a first or business class seat shell. Preferably, the non-horizontal wall is a vertical wall and, in the home position, the inner housing axis and outer housing axis are co-axial and extend generally horizontally, and the inner housing axis and outer housing axis are not co-axial in any of the adjustment positions.

In accordance with another aspect of the present invention there is provided a lighting assembly that includes an outer housing, an inner housing and a light member. The outer housing defines an outer housing axis, includes a front surface that defines a front opening therein and an inner surface that defines an adjustment cavity having a truncated spherical shape. The inner housing has a truncated spherical shape, defines an inner housing axis and is at least partially received within the adjustment cavity. The inner housing defines a light recess therein and includes a front cover having an aperture defined therein. The inner housing axis and the aperture are co-axial, and the front cover at least partially defines the light recess. The light member defines a light axis and is positioned within the inner housing. The light axis is not co-axial with the aperture. The inner housing is adjustable between a home position and a plurality of adjustment positions. In a preferred embodiment, the light axis and the inner housing axis are not parallel and form an angle therebetween.

In a preferred embodiment, the present invention provides a user seated in an aircraft seat the ability to illuminate his or her space in a controlled way. The reading light can be used, for example, for reading a book or the like when the cabin lights have been turned off. The light is a discrete unit that is typically mounted to a vertical surface in the furniture surrounding the passenger in a first or business class seat.

Generally, the light is a ball and socket type where the light emitting device is integrated into a generally spherically shaped body or inner housing that is able to rotate within a corresponding socket or cavity. In a preferred embodiment, the central axis of the light or light beam does not pass through the center of the spherical body in which the light emitting device is integrated. As a result, the light can be mounted directly to a generally vertical panel and the beam of light is angled in a usable direction (downwards toward the lap of the user) throughout the full range of the light's positional adjustment.

### BRIEF DESCRIPTION OF THE DRAWINGS

FIG. 1 is a perspective view of a lighting assembly in accordance with a preferred embodiment of the present invention;

FIG. 2 is a perspective view of the lighting assembly integrated within a first class seating arrangement on an aircraft;

FIG. 3 is a front elevational view of the lighting assembly;

FIG. 4 is a cross-sectional view of the lighting assembly taken along line 4-4 of FIG. 3 and showing the inner housing in the home position; and

FIG. 5 is a cross-sectional view of the lighting assembly with the inner housing in an adjustment position.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

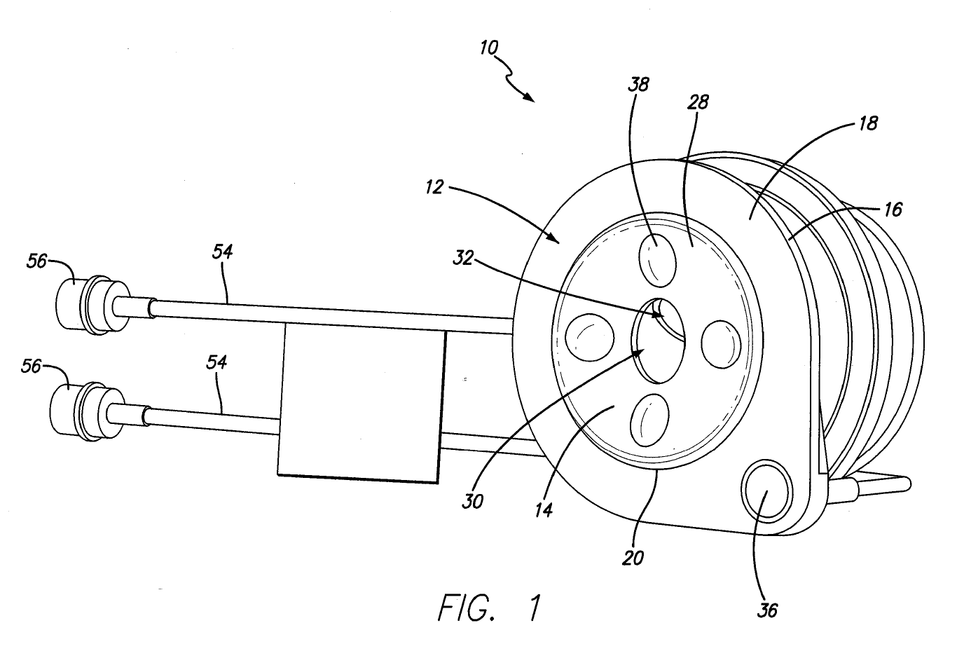

Referring now to the drawings, wherein the showings are for purposes of illustrating the present invention and not for purposes of limiting the same, FIGS. 1-5 show embodiments of a lighting assembly 10. In particular, the invention can be used on commercial passenger aircraft. However, this is not a limitation on the present invention and the lighting assembly 10 can be used elsewhere. In a preferred embodiment, the lighting assembly 10 is configured to be located in the business or first class section of the aircraft and in the space provided for a passenger. However, this is not a limitation on the present invention.

It should be understood, that the lighting assembly 10 can be implemented in other portions of the aircraft (the economy class section) and on aircraft monuments or components other than those associated with a passenger seat. For example, the reading light can be positioned in a lavatory monument wall or a galley monument wall or any other bulkhead or component.

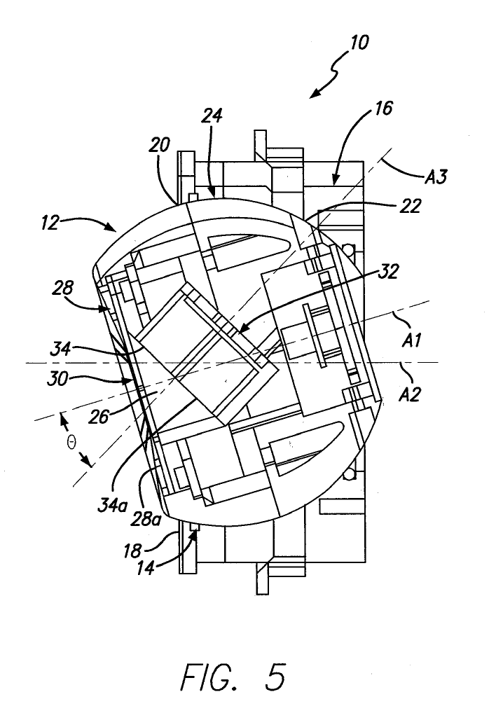

Generally, the lighting assembly 10 includes a “ball and socket” type assembly 12 that includes an inner housing 14 and an outer housing 16. The outer housing 16 includes a front surface 18 that defines a front opening 20 therein and an inner surface 22 that defines an adjustment cavity 24. The inner housing 14 and adjustment cavity 24 comprise complementary generally spherical shapes that allow the inner housing 14 to be adjusted within adjustment cavity 24 from a home position (shown in FIG. 4) and a plurality of adjustment positions (one of which is shown in FIG. 5). It will be appreciated that the spherically shaped inner housing 14 is truncated and not a complete sphere (as is shown in FIG. 4). The inner housing 14 defines an inner housing axis A1 and is at least partially received within the adjustment cavity 24, as is best shown in FIG. 4. The outer housing defines an outer housing axis A2.

In a preferred embodiment, the inner housing 14 defines a light recess 26 therein and includes a front cover 28 having an aperture 30 defined therein through which a beam of light can pass. Preferably, the aperture 30 is positioned in the center of the front cover 28 and is coaxial with inner housing axis A1. However, in another embodiment, the aperture 30 can be offset with respect to the center. The front cover 28 at least partially defines the light recess 26. In a preferred embodiment, the front cover 28 includes a front surface 28a that slopes inwardly toward the aperture 30. However, in another embodiment, the front surface 28a can be flat. As is shown in FIG. 4, in a preferred embodiment, the light member 32 is spaced from the front cover 28 and the aperture 30.

A light member 32 is positioned within the inner housing 14. In a preferred embodiment, the light member 32 includes a front lens member 34 that has a front surface 34a. The light member 32 defines a light axis A3 and the front surface 34a defines a center point C1. In a preferred embodiment, the light axis A3 and the inner housing axis A1 are not co-axial and not parallel, as is shown in FIG. 4. In a preferred embodiment, the inner housing axis A1 and the outer housing axis A2 are co-axial in the home position (see FIG. 4) and are not co-axial in any of the adjustment positions (see FIG. 5). In the home position, the outer housing axis A2 extends through the center of the front surface 34a of the lens 34. In a preferred embodiment, the light axis A3 and the inner housing axis A1 define an angle θ therebetween that is in the range of about 1° and about 89°. In a more preferred embodiment, the angle θ is between about 20° and about 70°. In the most preferred embodiment, the angle θ is between about 40° and about 50°.

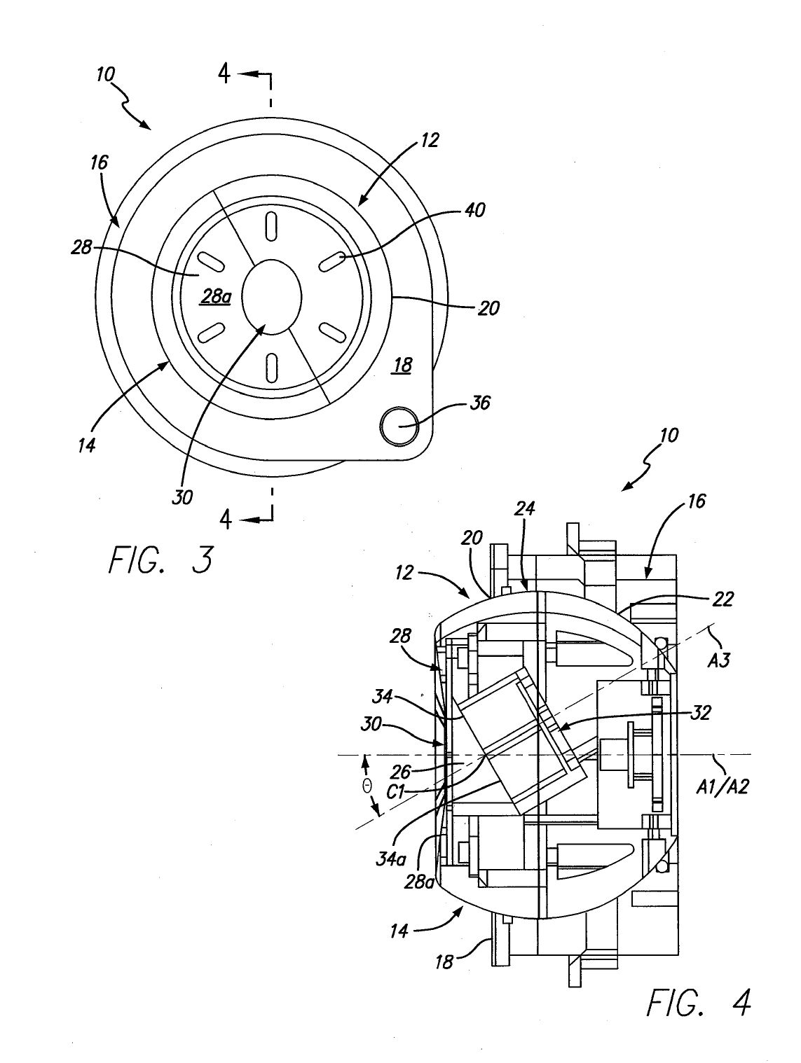

In a preferred embodiment, the lighting assembly 10 also includes an on/off switch 36. Any type of switch is within the scope of the present invention. In another embodiment, the switch 36 can be omitted from the lighting assembly 10 and can be located remotely, e.g., on the console surrounding the user's seat or on a multi-function touch screen device. In a preferred embodiment, as shown in FIG. 1, the lighting assembly 10 includes one or more adjustment indentations 38 that a user can use to help to adjust the light beam. In another embodiment, adjustment protrusions 40 or tabs can be implemented, as shown in FIG. 3.

As is best shown in FIG. 4, in a preferred embodiment, the light member 32 is positioned such that it is angled and not co-axial with the axis A1 of the inner housing 14. This angle makes it such that the beam of light emitted by light member 32 does not extend through the center (i.e., axis A1) of the inner housing 14 or aperture 30.

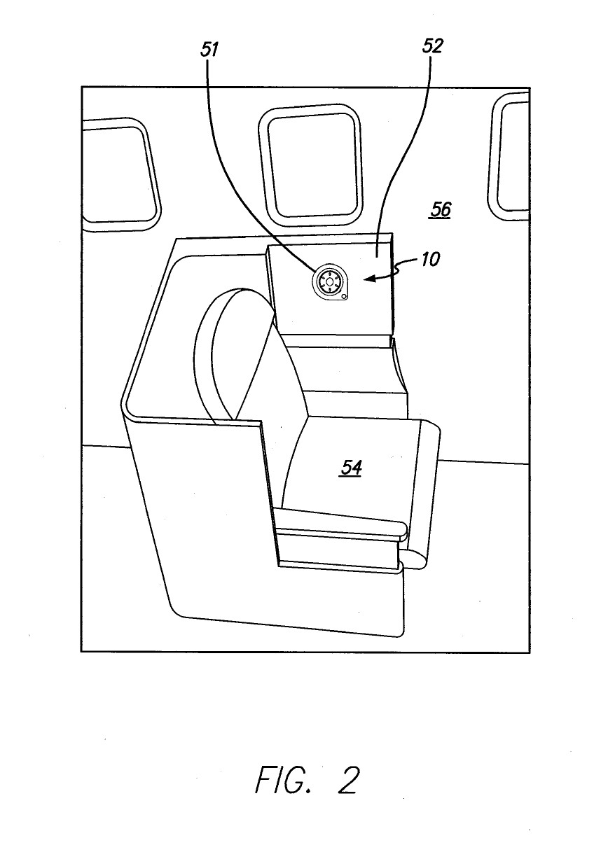

As is best shown in FIG. 2, as discussed above, in a preferred embodiment, the lighting assembly 10 is mounted in an opening 51 that is defined on a non-horizontal or vertical wall surface 52 (e.g., in a first class seat 54 on an aircraft 56). In this position, the front surface 18 of the outer housing 16 also has a non-horizontal or vertical orientation. However, this is not a limitation on the present invention and the lighting assembly 10 can be mounted on an angled or non-horizontal surface or wall. In another embodiment, the lighting assembly 10 can be mounted on a horizontal wall.

As is shown in FIG. 1, and as will be appreciated by those of ordinary skill in the art, the lighting assembly 10 includes wires 54 and sockets 56, that electrically communicate the light member 32, switch, 36, etc. to a power source. Any type of electrical connection is within the scope of the present invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A lighting assembly comprising:
an outer housing that defines an outer housing axis, wherein the outer housing includes a front surface that defines a front opening therein and an inner surface that defines an adjustment cavity having a truncated spherical shape,
an inner housing having a truncated spherical shape, wherein the inner housing defines an inner housing axis and is at least partially received within the adjustment cavity of the outer housing, wherein the inner housing defines a light recess therein and includes a front cover having an aperture defined therein, wherein the front cover at least partially defines the light recess, and
a light member positioned within the inner housing, wherein the light member defines a light axis, wherein the light axis and the inner housing axis are not co-axial and not parallel and form an angle therebetween, wherein the inner housing is adjustable between a home position and a plurality of adjustment positions.

2. The lighting assembly of claim 1 wherein in the home position the inner housing axis and outer housing axis are co-axial, and wherein the inner housing axis and outer housing axis are not co-axial in any of the adjustment positions.

3. The lighting assembly of claim 2 wherein the light member includes a front lens member having a front surface that defines a center point, wherein in the home position the outer housing axis passes through the center point, and wherein in any of the adjustment positions, the outer housing axis does not pass through the center point.

4. The lighting assembly of claim 1 wherein the front cover has a front surface that slopes inwardly toward the aperture.

5. The lighting assembly of claim 1 wherein the front cover includes adjustment protrusions thereon.

6. The lighting assembly of claim 1 wherein the front cover includes adjustment indentations thereon.

7. The lighting assembly of claim 1 wherein the front surface of the outer housing includes a switch thereon.

8. The lighting assembly of claim 1 wherein the angle is in the range of about 20° and about 70°.

9. The lighting assembly of claim 1 wherein the angle is in the range of about 40° and about 50°.

10. The lighting assembly of claim 1 wherein the light member is spaced from the front cover and the aperture.

11. A lighting assembly comprising:
an outer housing that defines an outer housing axis, wherein the outer housing includes a front surface that defines a front opening therein and an inner surface that defines an adjustment cavity having a truncated spherical shape,
an inner housing having a truncated spherical shape, wherein the inner housing defines an inner housing axis and is at least partially received within the adjustment cavity, wherein the inner housing defines a light recess therein and includes a front cover having an aperture defined therein, wherein the inner housing axis and the aperture are co-axial, and wherein the front cover at least partially defines the light recess, and
a light member positioned within the inner housing, wherein the light member defines a light axis, wherein the light axis is not co-axial with the aperture, wherein the inner housing is adjustable between a home position and a plurality of adjustment positions.

12. The lighting assembly of claim 11 wherein the light axis and the inner housing axis are not parallel and form an angle therebetween.

13. An aircraft that includes a non-horizontal wall having an opening defined therein, and a lighting assembly positioned in the opening, wherein the light assembly includes an outer housing that defines an outer housing axis, that includes a front surface that defines a front opening therein and an inner surface that defines an adjustment cavity having a truncated spherical shape, an inner housing having a truncated spherical shape, wherein the inner housing defines an inner housing axis and is at least partially received within the adjustment cavity, wherein the inner housing defines a light recess therein and includes a front cover having an aperture defined therein, wherein the front cover at least partially defines the light recess, and a light member positioned within the inner housing, wherein the light member defines a light axis, wherein the light axis and the inner housing axis are not co-axial and not parallel and form an angle therebetween, wherein the inner housing is adjustable between a home position and a plurality of adjustment positions.

14. The aircraft of claim 13 wherein the non-horizontal wall is a portion of a first or business class seat shell.

15. The aircraft of claim 14 wherein the non-horizontal wall is a vertical wall.

16. The aircraft of claim 15 wherein in the home position the inner housing axis and outer housing axis are co-axial and extend generally horizontally, and wherein the inner housing axis and outer housing axis are not co-axial in any of the adjustment positions.
